(19) United States
(12) Patent Application Publication
(10) Pub. No.: US 2009/0064816 A1
(43) Pub. Date: Mar. 12, 2009

(54) KICK DOWN SWITCH OF ACCELERATOR PEDAL APPARATUS

(75) Inventors: Kyungmin KIM, Busan (KR); Hojong OH, Busan (KR)

Correspondence Address: THE RAFFERTY PATENT LAW FIRM, 1952 Gallows Road, Suite 200, Vienna, VA, 22182-3823, US

(73) Assignee: DONGHEE INDUSTRIAL CO., LTD., Ulsan Metropolitan City (KR)

(21) Appl. No.: 12/209,204

(22) Filed: Sep. 11, 2008

(30) Foreign Application Priority Data
Sep. 11, 2007 (KR) 10-2007-0092278

(51) Int. Cl. G05G 1/30

(52) U.S. Cl. 74/514

(57) ABSTRACT

The present invention relates to a kick down switch of an accelerator pedal apparatus, and can provide kick-down operation feeling to a driver through a housing protrusion that selectively comes in contact with a second lever protrusion of a switch lever according to a rotation angle of a pedal arm. Accordingly, it is possible to improve operational feeling, to reduce fatigue, and to meet both stability and economical efficiency.

### CROSS-REFERENCE TO RELATED APPLICATIONS

The present application is based on, and claims priority from, Korean Application Serial Number 10-2007-0092278, filed on Sep. 11, 2007, the disclosure of which is hereby incorporated by reference herein in its entirety.

### FIELD OF THE INVENTION

The present invention relates to a kick down switch of an accelerator pedal apparatus that provides kick-down operation feeling to a driver, thereby improving operational feeling, reducing fatigue, and meeting both stability and economical efficiency.

### BACKGROUND OF THE INVENTION

In general, when a vehicle quickly requires normal speed before entering an express highway or intends to pass a vehicle ahead, that is, when a vehicle should be quickly accelerated, kick down switches are formed to allow all kinds of vehicles more rapidly travel. When a driver kicks an accelerator pedal and a throttle valve is thus fully opened, a vehicle is quickly accelerated thereafter while a transmission is automatically shifted to a low stage (automatic transmission vehicle), and a manual transmission vehicle is accelerated by shift down.

Meanwhile, in recent years, all kinds of automatic transmission vehicles have the above-mentioned kick-down function, but a function of providing kick-down operation feeling to a driver through an accelerator pedal is insufficient. For this reason, the function of providing kick-down operation feeling to a driver is being actively researched.

### SUMMARY OF THE INVENTION

Embodiments of the present invention provide a kick down switch of an accelerator pedal apparatus that provides kick-down operation feeling, which is generated during the traveling, to a driver, thereby improving driver's operational feeling, reducing fatigue, and meeting both stability and economical efficiency.

According to an embodiment of the present invention, a kick down switch of an accelerator pedal apparatus includes a switch housing, a switch lever, and a spring member. The switch housing is fixed to a pedal arm, and includes a housing protrusion that protrudes from an inner wall thereof toward an inner receiving space. The switch lever is provided in the switch housing so as to come in contact with the pedal arm housing and the housing protrusion during the operation of the pedal arm. Both ends of the spring member are fixed to the switch housing and the switch lever so that the spring member provides an elastic reaction force to the switch lever so as to provide kick-down operation feeling to a driver through the pedal arm when the housing protrusion and the switch lever come in contact with each other.

The kick down switch according to the embodiment of the present invention is mounted on an accelerator pedal apparatus, and provides kick-down operation feeling to a driver according to the operation of the pedal arm, thereby improving operational feeling, reducing fatigue, and meeting both stability and economical efficiency.

### BRIEF DESCRIPTION OF THE DRAWINGS

For a better understanding of the nature and objects of the present invention, reference should be made to the following detailed description with the accompanying drawings, in which:

FIGS. 1 and 2 are views illustrating a kick down switch mounted on an accelerator pedal apparatus according to an embodiment of the present invention;

FIG. 3 is an exploded perspective view of the kick down switch according to the embodiment of the present invention;

FIG. 4 is a cross-sectional view of the assembled kick down switch according to the embodiment of the present invention; and

FIGS. 5 and 6 are views illustrating the operation of the kick down switch according to the embodiment of the present invention.

### DETAILED DESCRIPTION OF THE PREFERRED EMBODIMENTS

An embodiment of the present invention will be described in detail below with reference to accompanying drawings.

A kick down switch according to the embodiment of the present invention is mounted on an accelerator pedal apparatus, and the accelerator pedal apparatus is an apparatus that can improve driver's operational feeling, reduce fatigue, and meet both economical efficiency and stability.

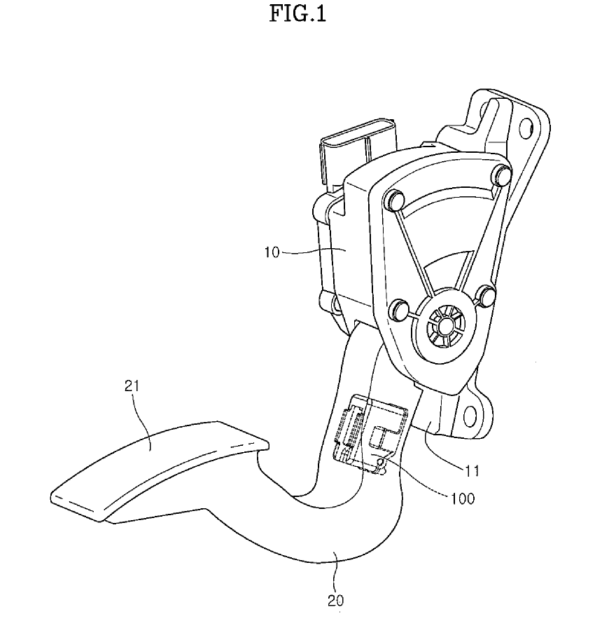

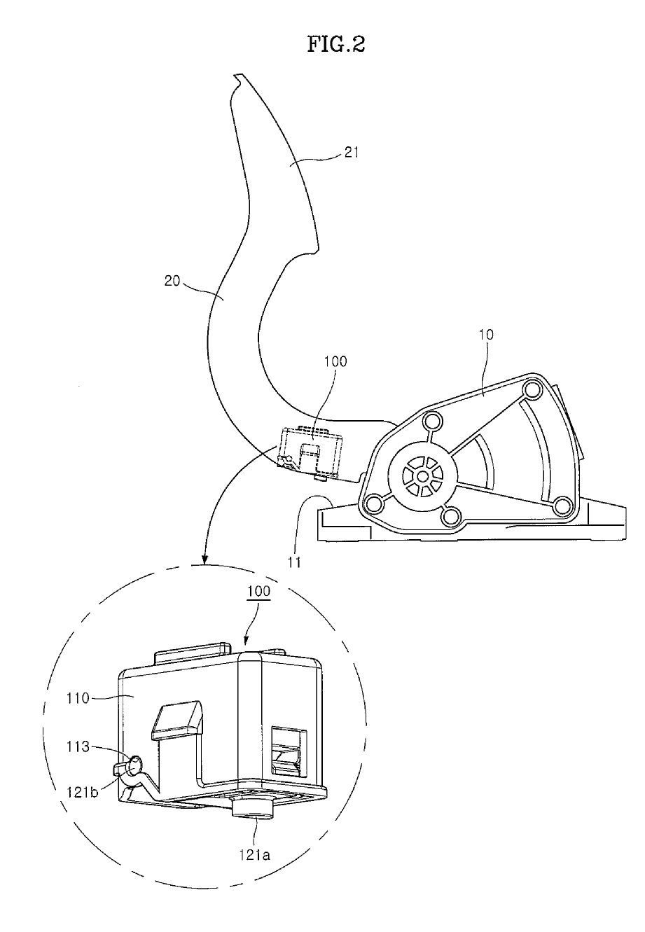

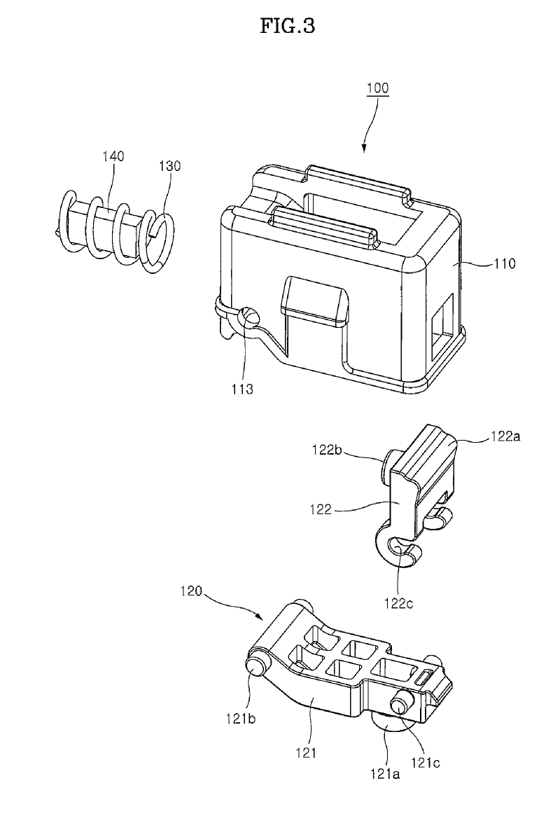

As shown in FIGS. 1 and 2, the accelerator pedal apparatus includes a pedal arm housing 10 that is fixed to a dashboard (not shown) provided below a driver's seat, and a pedal arm 20 of which one end is rotatably hinge-connected to pedal arm housing 10 and the other end thereof is integrally formed with a pedal 21.

A kick down switch 100 according to the embodiment of the present invention is fixed to pedal arm 20.

Kick down switch 100 according to the embodiment of the present invention includes a switch housing 110, a switch lever 120, a spring member 130, and a noise reducing member 140. The switch housing is fixed to pedal arm 20, and includes a housing protrusion 112 that protrudes from the inner wall thereof toward an inner receiving space 111. The switch lever is provided in switch housing 110 so as to come in contact with pedal arm housing 10 and housing protrusion 112 during the operation of pedal arm 20. Both ends of spring member 130 are fixed to switch housing 110 and switch lever 120 so that the spring member provides an elastic reaction force to switch lever 120 so as to provide kick-down operation feeling to a driver through pedal arm 20 when housing protrusion 112 and switch lever 120 come in contact with each other. The noise reducing member is disposed in spring member 130 so as to reduce the noise caused by the resonance that is generated when the length of spring member 130 is rapidly changed due to the operation of switch lever 120.

When being rotated with respect to pedal arm housing 10, a part of pedal arm 20 faces a portion 11 of pedal arm housing 10 that is fixed to the dashboard below the driver's seat. Switch housing 110 is fixed to this portion.

Switch housing 110 is inserted into a receiving space (not shown) formed in pedal arm 20 and then welded to the pedal arm, thereby being fixed to the pedal arm.

Switch housing 110 has a rectangular parallelepiped appearance, and receiving space 111 formed in the switch housing is opened toward pedal arm housing 10.

Hinge holes 113, which are used to connect the switch housing with switch lever 120, are formed in switch housing 10.

Switch lever 120 includes a first lever 121 and a second lever 122. The first lever includes a first lever protrusion 121a coming in contact with pedal arm housing 10 during the operation of pedal arm 20. One end of the first lever is hinge-connected to switch housing 110 so that the first lever can be rotated in receiving space 111 when pedal arm housing 10 and first lever protrusion 121a come in contact with each other. One end of the second lever is rotatably hinge-connected to first lever 121, and a second lever protrusion 122a coming in contact with housing protrusion 112 protrudes from the other end thereof.

Hinge protrusions 121b, which protrude from both surfaces of one end of first lever 121, and hinge protrusions 121b are fitted to hinge holes 113 formed in switch housing 110.

The both ends of spring member 130 are fitted to spring protrusions 114 and 122b, which are formed on switch housing 10 and second lever 122, so that the spring member is provided in a linear shape.

Hinge protrusions 121c protrudes from both surfaces of a portion of first lever 121 adjacent to first lever protrusion 121a, and hook-shaped hinge grooves 122c fitted to hinge protrusions 121c are formed at one end of second lever 122 facing first lever 121.

Housing protrusion 112 is formed to include an inclined section 112a, a maximum protrusion section 112b, and a protrusion decrease section 112c. The inclined section protrudes from the inner wall of switch housing 110 so as to be inclined, and allows a driver to perceive that this section is a kick-down start portion when coming in contact with second lever protrusion 122a by pedal arm 20. The maximum protrusion section continuously protrudes from inclined section 112a, and allows a driver to perceive that this section is a kick-down maximum portion when coming in contact with second lever protrusion 122a. The protrusion decrease section continuously protrudes from maximum protrusion section 112b, and allows a driver to perceive that this section is a maximum rotated portion of pedal arm 20 when coming in contact with second lever protrusion 122a. A groove 115, into which second lever protrusion 122a is inserted when first lever protrusion 121a does not come in contact with pedal arm housing 10, is formed at a portion of the inner wall of switch housing 110 connected to inclined section 112a.

Noise reducing member 140 is made of an ethylene propylene rubber (EPDM) that is excellent in vibration insulation and noise reduction. However, the present invention is not limited thereto.

Noise reducing member 140 may also be made of a sponge.

The operation of the embodiment according to the present invention will be described below.

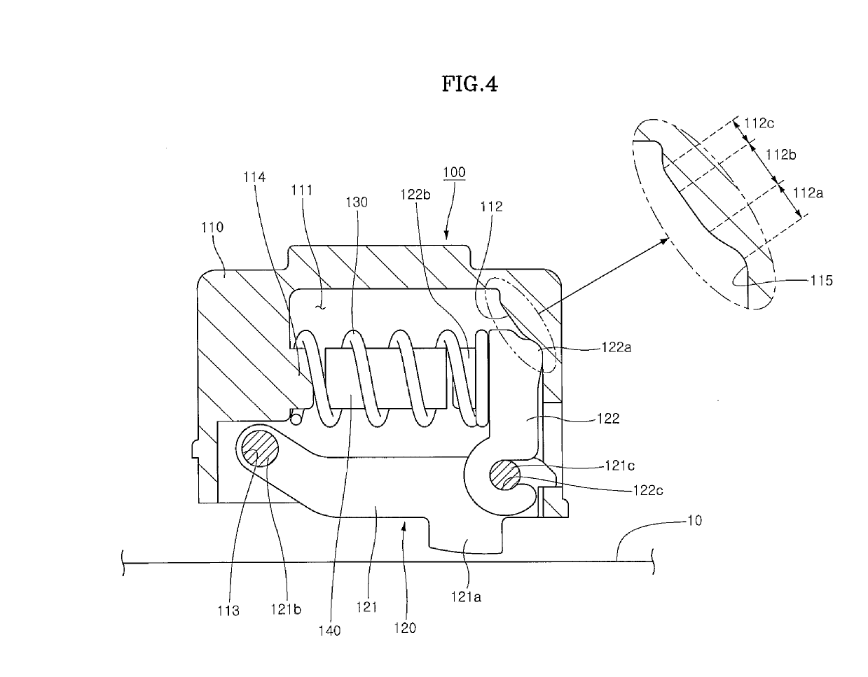

In FIG. 4, a force is not applied to pedal 21 and pedal arm 20 is not rotated with respect to pedal arm housing 10.

In this case, first lever protrusion 121a of first lever 121 is spaced apart from pedal arm housing 10, and second lever protrusion 122a of second lever 122 is inserted into groove 115 formed on the inner wall of switch housing 10.

In this state, if a force is applied to pedal 21 and pedal arm 20 is rotated with respect to pedal arm housing 10 due to the applied force, first lever protrusion 121a comes in contact with pedal arm housing 10.

In this case, first lever 121 is rotated about hinge protrusions 121b in a counterclockwise direction from the position shown in FIG. 4, and second lever 122 connected to the first lever through hinge protrusions 121c is moved upward from the position shown in FIG. 4.

Accordingly, second lever protrusion 122a inserted into groove 115 is separated from groove 115 and comes in contact with inclined section 112a of housing protrusion 112.

When housing protrusion 112 comes in contact with inclined section 112a, the upper end of second lever 122 is slightly moved to the left side from the position shown in FIG. 4 against the force of spring member 130 and the restoring force of spring member 130 is transmitted to second lever 122 again.

The restoring force of spring member 130, which is transmitted to second lever 122, is transmitted to pedal arm housing 10. However, since pedal arm housing 10 is fixed to the dashboard, pedal arm housing 10 is not pushed. In contrast, the force pushing pedal arm housing 10 is substantially produced on switch housing 110 as a reaction force.

In this case, the reaction force is transmitted to a driver through pedal arm 20, so that the driver can perceive that the present time is kick-down start time through pedal arm 20.

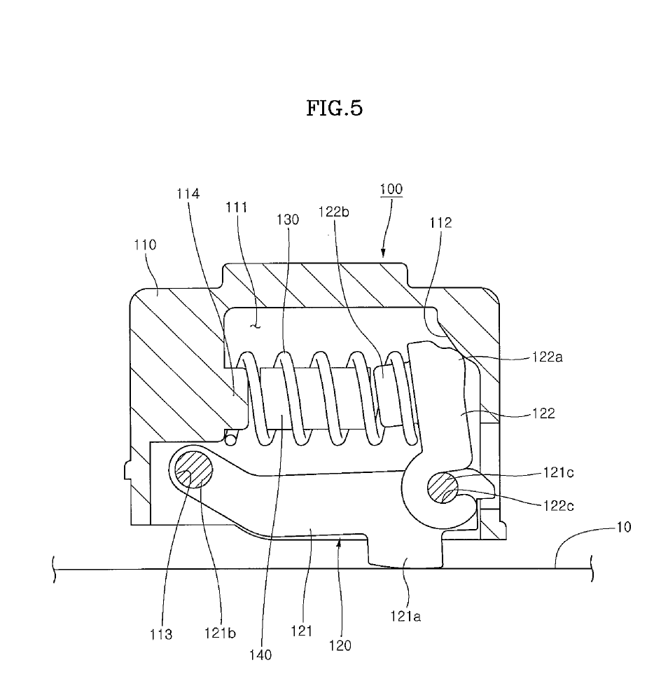

In this state, the driver further steps on pedal 21 to increase the force applied to pedal 21. Accordingly, the rotation angle of pedal arm 20 is further increased, so that first lever 121 is further rotated in the counterclockwise direction and is in the position shown in FIG. 5.

In FIG. 5, second lever protrusion 122a is separated from inclined section 112a and comes in contact with maximum protrusion section 112b. Further, the pushing force of spring member 130, which is caused by second lever 122, is maximum.

Accordingly, the reaction force of spring member 130 is maximum, and the driver receiving reaction force through pedal arm 20 can accurately perceive that the present time is kick-down maximum time.

Therefore, according to the embodiment of the present invention, it is possible to provide improved operational feeling to a driver, to significantly reduce fatigue caused by the operation of pedal arm 20, and to meet both stability and economical efficiency.

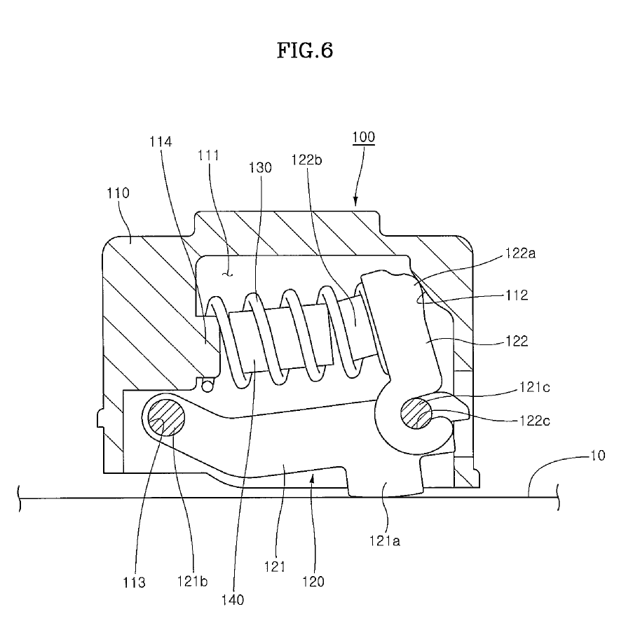

Meanwhile, in FIG. 6 shows a state where the maximum force is applied to pedal 21 by a driver.

In this state, second lever protrusion 122a is separated from maximum protrusion section 112b and comes in contact with protrusion decrease section 112c. Accordingly, a driver receives the decreased reaction force of spring member 130 through pedal arm 20.

Further, in FIG. 6, a driver has felt the maximum kick-down operation feeling. Therefore, a driver does not apply an excessive force.

After that, if a driver removes a force applied to pedal 21, first and second levers 121 and 122 return to the initial positions as shown in FIG. 4 by the restoring force of spring member 130. Then, the first and second levers are ready for the next operation.

What is claimed is:

1. A kick down switch of an accelerator pedal apparatus comprising:
a switch housing that is fixed to a pedal arm, and includes a housing protrusion that protrudes from an inner wall thereof toward an inner receiving space;
a switch lever that is provided in the switch housing so as to come in contact with the housing protrusion during the operation of the pedal arm; and
a spring member of which both ends are fixed to the switch housing and the switch lever so that the spring member provides an elastic reaction force to the switch lever so as to provide kick-down operation feeling to a driver through the pedal arm when the housing protrusion and the switch lever come in contact with each other.

2. The kick down switch as defined in claim 1, further comprising:
a noise reducing member that is disposed in the spring member so as to reduce the noise caused by the resonance that is generated when the length of the spring member is rapidly changed due to the operation of the switch lever.

3. The kick down switch as defined in claim 1, wherein the switch lever includes:
a first lever which includes a first lever protrusion coming in contact with the pedal arm housing during the operation of the pedal arm, and of which one end is hinge-connected to the switch housing so that the first lever is rotated in the receiving space when the pedal arm housing and the first lever protrusion come in contact with each other; and
a second lever of which one end is rotatably hinge-connected to the first lever, and which includes a second lever protrusion coming in contact with the housing protrusion protruding from the other end thereof.

4. The kick down switch as defined in claim 3, wherein the both ends of the spring member are fitted to the spring protrusions, which are formed on the switch housing and the second lever, so that the spring member is provided in a linear shape.

5. The kick down switch as defined in claim 3, wherein hinge protrusions protrudes from both surfaces of the first lever adjacent to the first lever protrusion, and
hook-shaped hinge grooves fitted to the hinge protrusions are formed at one end of the second lever facing the first lever.

6. The kick down switch as defined in claim 3, wherein the housing protrusion includes: an inclined section that protrudes from the inner wall of the switch housing so as to be inclined, and allows a driver to perceive that this section is a kick-down start portion when coming in contact with the second lever protrusion by pedal arm; a maximum protrusion section that continuously protrudes from the inclined section, and allows a driver to perceive that this section is a kick-down maximum portion when coming in contact with the second lever protrusion; and a protrusion decrease section that continuously protrudes from the maximum protrusion section, and allows a driver to perceive that this section is a maximum rotated portion of the pedal arm when coming in contact with the second lever protrusion, and
a groove, into which the second lever protrusion is inserted when the first lever protrusion does not come in contact with the pedal arm housing, is formed at a portion of the inner wall of the switch housing connected to the inclined section.

7. The kick down switch as defined in claim 2, wherein the noise reducing member is made of an ethylene propylene rubber (EPDM).

8. The kick down switch as defined in claim 2, wherein the noise reducing member is made of a sponge.
